(19) United States
(12) Patent Application Publication
(10) Pub. No.: US 2021/0149671 A1
(43) Pub. Date: May 20, 2021

(54) DATA STRUCTURES AND METHODS FOR ENABLING CROSS DOMAIN RECOMMENDATIONS BY A MACHINE LEARNING MODEL

(71) Applicant: Intuit Inc., Mountain View, CA (US)

(72) Inventors: Oren Sar Shalom, Nes Ziona (IL); Meng Chen, Sunnyvale, CA (US); Linxia Liao, Fremont, CA (US); Yehezkel Shraga Resheff, Jerusalem (IL)

(73) Assignee: Intuit Inc., Mountain View, CA (US)

(21) Appl. No.: 16/688,697

(22) Filed: Nov. 19, 2019

(51) Int. Cl. G06F 9/30; G06N 5/02; G06N 3/08

(52) U.S. Cl. CPC G06F 9/30036; G06N 3/08; G06N 5/022

(57) ABSTRACT

A machine learning method. A source domain data structure and a target domain data structure are combined into a unified data structure. First data in the source domain data structure are latent with respect to second data in the target domain data structure. The unified data structure includes user vectors that combine the first data and the second data. The user vectors are transformed into a transformed data structure by applying a mapping function to the user vectors. The mapping function relates, using at least one parameter, first relationships in the source domain data structure to second relationships in the target domain data structure. The at least one parameter is based on a combination of affinity scores relating items with which the user interacted and did not interact. The transformed data structure is input into a machine learning model, from which is obtained a recommendation relating to the target domain.

### BACKGROUND

Certain machine learning models may be used as automatic recommendation systems. For example, a user watches movies on a streaming service. The streaming service records which movies the user watches, along with other data, and then uses a machine learning model to determine the kinds of movies that the user likes to watch. The machine learning model may output a recommendation to the user to watch some movie that the user has not yet watched on the streaming service, but which corresponds in some way to the past movies which the user has watched on the streaming service.

### SUMMARY

The one or more embodiments include a method. The method includes combining a source domain data structure and a target domain data structure to form a unified data structure. First data in the source domain data structure are latent with respect to second data in the target domain data structure. The unified data structure includes user vectors that combine the first data and the second data. The method also includes transforming the user vectors, to generate a transformed data structure, by applying a mapping function to the user vectors. The mapping function relates, using at least one parameter, first relationships in the source domain data structure to second relationships in the target domain data structure. The at least one parameter is based on a combination of: a) a first affinity score relating the at least one user to a first subset of the second items with which the at least one user interacted, and b) a second affinity score relating the at least one user to a second subset of the second items in the target domain with which the at least one user did not interact. The method also includes submitting the transformed data structure into a machine learning model. The method also includes obtaining, from the machine learning model, a recommendation relating to the target domain.

The one or more embodiments also include a system. The system includes a data repository. The data repository stores a source domain data structure including first relationships between first users to first items in a source domain. The data repository also stores a target domain data structure including second relationships between second users to second items in a target domain. First data in the source domain data structure is latent with respect to second data in the second domain data structure. The data repository also stores a unified data structure including vectors that combine the first data and the second data. The data repository also stores at least one parameter based on a combination of: a) a first affinity score relating the at least one user to a first subset of the second items with which the at least one user interacted, and b) a second affinity score relating the at least one user to a second subset of the second items in the target domain with which the at least one user did not interact. The data repository also stores a mapping function which relates, using the at least one parameter, the first relationships in the source domain to the second relationships in the target domain. The data repository also stores a transformed data structure including a transformation of the user vectors. The data repository also stores program code. The system also includes a transformation engine configured to execute the program code to unify the source domain data structure and the target domain data structure to form the unified data structure. The transformation engine is further configured to execute the program code to generate the transformed data structure by applying the mapping function to the user vectors.

The one or more embodiments also include a non-transitory computer readable storage medium storing program code, which when executed by a computer, performs a computer-implemented method. The program code includes program code for combining a source domain data structure and a target domain data structure to form a unified data structure. First data in the source domain data structure are latent with respect to second data in the target domain data structure. The unified data structure includes user vectors that combine the first data and the second data. The program code also includes program code for transforming the user vectors, to generate a transformed data structure, by applying a mapping function to the user vectors. The mapping function relates, using at least one parameter, first relationships in the source domain data structure to second relationships in the target domain data structure. The at least one parameter is based on a combination of: a) a first affinity score relating the at least one user to a first subset of the second items with which the at least one user interacted, and b) a second affinity score relating the at least one user to a second subset of the second items in the target domain with which the at least one user did not interact. The program code also includes program code for submitting the transformed data structure into a machine learning model. The program code also includes program code for obtaining, from the machine learning model, a recommendation relating to the target domain.

Other aspects of the invention will be apparent from the following description and the appended claims.

### BRIEF DESCRIPTION OF DRAWINGS

FIG. 1 illustrates an example of a recommender machine learning system, in accordance with one or more embodiments.

FIG. 2 illustrates an example of a cold start issue in a recommender machine learning system, in accordance with one or more embodiments.

FIG. 3 illustrates a system for enabling cross domain recommendations by a machine learning model, in accordance with one or more embodiments.

FIG. 4 illustrates a recommender machine learning model, in accordance with one or more embodiments.

FIG. 5 illustrates a method for enabling cross domain recommendations by a machine learning model, in accordance with one or more embodiments.

FIG. 6 illustrates a specific example of data structures used in a method for enabling cross domain recommendations by a machine learning model, in accordance with one or more embodiments.

FIG. 7A and FIG. 7B show a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention relate to data structures and methods for enabling cross domain recommendations by a machine learning model. A “domain,” as used herein, is a field of data that relates to a particular topic or operation of a particular software program. The domain may be a grouping of data and operations. A “source domain,” as used herein, is a domain which is rich in data with respect to a selected user. A “target domain,” as used herein, is a domain which is poor in data with respect to the selected user. The target domain is the target for providing recommendations. The term “rich” is defined as sufficient data such that a machine learning model of a machine learning recommendation system has enough data to make a meaningful recommendation. The term “poor” is defined as insufficient data such that a machine learning model of a machine learning recommendation system has insufficient data to make a meaningful recommendation. A recommendation is “meaningful” if the recommendation exceeds a threshold probability, selected by a computer programmer or automatically, that the recommendation semantically relates to an input vector supplied to the machine learning model. The one or more embodiments assume that the domain of interest is the target domain, which is poor in data. Thus, the one or more embodiments relate to using a source domain as input to a machine learning model to achieve meaningful recommendations in the target domain (i.e., a “cross-domain” recommendation). Expressed differently, the one or more embodiments relate to techniques for mitigating the “cold start problem” in machine learning recommendation systems. The “cold start problem” occurs when a machine learning model has too little, but at least some, data for the computer to make a meaningful prediction or recommendation. The “cold start” problem is contrasted with the “extreme cold start problem,” which occurs when a machine learning model has no data for the computer to make a meaningful prediction or recommendation. Unless specified otherwise herein, it is assumed that at least some data exists in the target domain (i.e., the one or more embodiments are directed towards mitigating the “cold start problem” as opposed to the “extreme cold start” problem).

For example, if a user has too few past interactions with a service, then a machine learning model cannot model the user preferences or cannot model the user preferences inadequately with respect to the intended purposes of the owner of the service. To mitigate the “cold start problem,” the one or more embodiments provide for a technique to use the source domain to supplement the data in the target domain. However, in most cases, and as assumed herein unless stated otherwise, the data in the source domain is latent with respect to the target domain. In other words, the data in the source domain does not have a clear meaning with respect to data in the target domain. Accordingly, the data in the source domain cannot be applied directly to the machine learning model to generate meaningful recommendations or predictions with respect to matters involving the target domain of interest. Thus, the one or more embodiments provide for a mapping function and specifically improved data structures which allow a machine learning model to apply data from the source domain to the target domain and then generate a meaningful model or prediction of user preferences with respect to the target domain.

FIG. 1 illustrates an example of a recommender machine learning system, in accordance with one or more embodiments. FIG. 1 provides a general overview of how a recommender machine learning model system may be used with respect to a service.

In particular, the service in FIG. 1 is a streaming movie service. In the example of FIG. 1, a user pays a fee to the streaming movie service, and in turn the streaming movie service allows the user to stream movies over an Internet connection. The streaming movie service may have a library of thousands, or even tens of thousands, of movies available for streaming. However, the user may not be able to or want to search the whole library for movies of interest to the user. Thus, in order to increase the user's interest in retaining a subscription to the streaming movie service, the streaming movie service uses a recommender machine learning model (100) to model user movie-watching preferences. The model may then be used to predict which movies in the library, that have not yet been watched by the user, may be of interest to the user. The resulting list of recommended, but unwatched, movies may then be presented to the user.

In the example of FIG. 1, the target domain (102) is data about movie watching by the user. In the example of FIG. 1, the user has watched hundreds of movies. Thus, the target domain (102) is considered to be rich in data. Accordingly, the recommender machine learning model (100) has plenty of data in the target domain (102) with which to make a recommendation to the user regarding movies for the user to watch in the future.

The recommender machine learning model (100) learns a pattern of the user's movie watching habits that the user appears to predominately watch movies that somehow relate to animals. Thus, the recommender machine learning model (100) predicts that the user may like certain movies in the library, that the user has not yet watched, that also relate to animals. In the example of FIG. 1, the recommender ranks three movie titles as being the most likely to be of interest to the user. The three movie titles in FIG. 1 are fictious, used as examples only, and include “Lord of the Nudibranch,” “The Nematode Diaries,” and “Fleeced: A Shearer's Tale.” These movie titles, along with images representing the movies, are then presented in a user interface (104) for the user's consideration.

In effect, the streaming movie service, via the recommender machine learning model (100), has done the work of searching through the library for movies of interest to the specific user. More generally, each user of the streaming movie service may receive their own personalized recommendation of movies of interest to each individual user. As a result, the streaming movie service is more likely to retain user interest, and hence retain subscriptions to the streaming movie service.

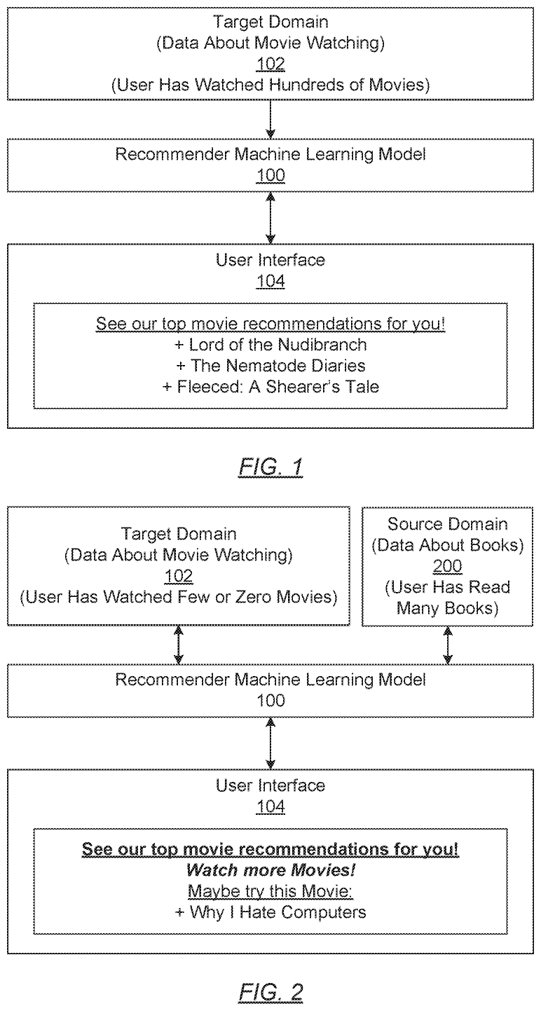

FIG. 2 illustrates an example of a cold start issue in a recommender machine learning system, in accordance with one or more embodiments. FIG. 2 is a continuation of the example of FIG. 1, and thus the recommender machine learning model (100), the target domain (102), and the user interface (104) are the same as described in FIG. 1.

In the example of FIG. 2, the user is new to the streaming movie service. Thus, the user has watched no movies yet, or perhaps the user has watched only a few movies. In any case, the user has generated very little data about movie watching in the online movie streaming service. Thus, the target domain data is insufficient for the recommender machine learning model (100) to generate a valid recommendation relating to the target domain (102) (movies).

However, the company that owns the streaming movie service also owns an online book selling service, for both electronic books and paper books. In the example of FIG. 1, the user has been a customer of the online book selling service for many years and has ordered hundreds of books from the online book selling service. Thus, the company has a source domain (200) regarding book reading habits of the user that is data rich.

However, the data in the source domain (200) is latent with respect to the data in the target domain (102). Again, “latent” means that the data in the source domain (200) does not have a clear meaning with respect to data in the target domain (102). Latent features of the source domain (200) are optimized for the source domain (200). Thus, the latent features do not translate directly to the target domain (102).

For example, simply because a user likes to read non-fiction books does not imply that a user prefers to watch non-fiction movies. In a more specific example, the user may prefer to watch fiction movies about superheroes but prefer to read non-fiction books about history. Still further, the data in the source domain (200) may be stored in a different format that the data in the target domain (102).

Further yet, the data in the source domain (200) may be expressed in terms of values for features that do not have a clear meaning in the target domain (102). For example, a feature in the source domain (200) may be “book length,” with a value of “513” pages; however, the number “513” has an unclear meaning with respect to the target domain (102) of movie watching, and may have no meaning at all in the target domain (102).

In the specific example of FIG. 2, assume that the user has an established history of reading books that argue for a return to more primitive technologies relative to the information age, and argue against advancing computer related technologies. However, in the example of FIG. 1, the user's actual interest is in animals and has only read those books to study the usefulness of animals to daily living “off the grid.” Thus, if the recommender machine learning model (100) were to only use data from the recommender machine learning model (100), then the recommendation may be for a movie entitled “Why I Hate Computers.” However, the recommended movie is of no interest to the user, whose actual interest is in animals.

The user interface (104) may also display a prompt such as “watch more movies!” to encourage the user to develop more data in the target domain (102).

However, the user may scorn the prompt and decide that the streaming movie service is of little interest to the user, even if many movies about animals are available in the library.

Note that simply adding the data in the source domain (200) to the target domain (102) is not practical, or may be impossible, and does not solve the cold start problem. For example, the data in the two domains are likely in different formats. In another example, the data in the source domain (200) is latent with respect to the data in the target domain (102).

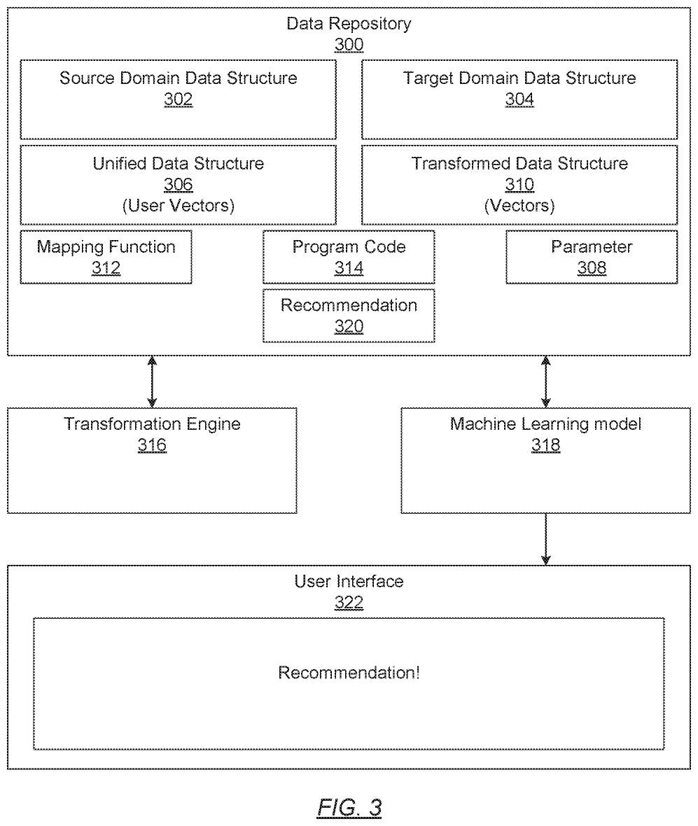

Nevertheless, there is data in the source domain (200) that might be properly related to the target domain (102), if the proper mapping function and data structures could be applied to the recommender machine learning model (100). Thus, attention is now turned to FIG. 3 which provides for a system for mitigating the cold start problem described with respect to FIG. 1 and FIG. 2.

FIG. 3 illustrates a system for enabling cross domain recommendations by a machine learning model, in accordance with one or more embodiments. The term “cross domain” refers to different data domains, where one domain contains data that is latent with respect to the other domain. FIG. 3 illustrates a system for using data from a source domain of data (e.g., “books”) in a recommender machine learning model meant to generate improved predictions with respect to a target domain of data (e.g., “movies”). Again, as used herein, an assumption is made that the data in the source domain is latent with respect to other data in the target domain.

In one or more embodiments of the invention, the data repository (300) is any type of storage unit and/or device (e.g., a file system, database, collection of tables, or any other storage mechanism) for storing data. Further, the data repository (300) may include multiple different storage units and/or devices. The multiple different storage units and/or devices may or may not be of the same type or located at the same physical site.

The data repository (300) stores several data structures and several different types of information. For example, the data repository (300) stores a source domain data structure (302). The source domain data structure (302) may be a table, a vector, a tree, a tree, or some other data structure. The source domain data structure (302) may be configured for input to a machine learning model that is different that the machine learning model (318) described below. Thus, in the example of FIG. 3, the source domain data structure (302) is not properly formatted for input into the machine learning model (318) described below. Accordingly, the structure of the source domain data structure (302) may not be useful as an input to the machine learning model (318) described below.

The source domain data structure (302) includes data that represents relationships between first users to first items in a source domain. A source domain is an ontological term which refers to data that relates to a particular subject. A relationship is at least one datum that indicates a logical connection between a user and an item. A user is defined as a user identification expressed as a value that represents a human person that interacts with the source domain in some way. An item is a specific instance of the type of data within the domain (here, the source domain).

For example, without limiting other possible embodiments of the system shown in FIG. 3, a source domain may be data that relates to “Software Alpha,” which may be an online financial management application that is designed to help a person manage the person's finances. The “user” is an identification value that represents a specific person. An item may be a record of a number of times that a user has used “function X” of the financial management application.

The data repository (300) also stores a target domain data structure (304).

The target domain data structure (304) includes data representing second relationships between a second users to second items in the target domain. The target domain data structure (304) may be a table, a vector, a tree, a tree, or some other data structure. The target domain data structure (304) may be configured for input to the machine learning model (318) described below. However, the amount of data in the target domain data structure (304) is insufficient for the machine learning model (318) to generate a recommendation.

For example, again without limiting other possible embodiments of FIG. 3, the target domain data structure (304) may contain information related to another software application, Software Beta. Software beta may be a tax preparation program which may or may not be compatible with the financial management application of Software Alpha. However, the user may not have used any of the features of Software Beta, and thus the target domain data structure (304) is mostly empty.

In the system of FIG. 3, first data in the source domain data structure (302) is latent with respect to second data in the target domain data structure (304). However, the first users and the second users may include at least one user in common.

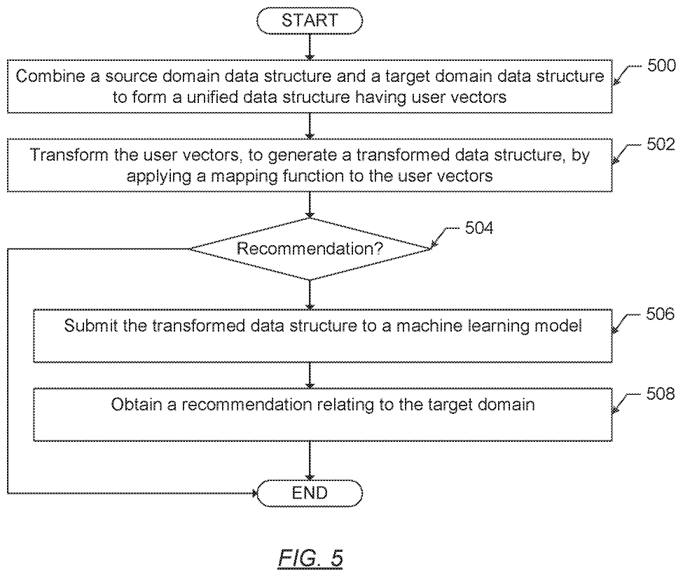

The data repository (300) also stores a unified data structure (306). The unified data structure (306) may be one or more user vectors that combine the first data and the second data. The unified data structure (306) may take the form of table, a vector, a tree, a tree, or some other data structure. However, the unified data structure (306) does contain items from both the source domain and the target domain that are associated with a given user identifier. Generation of the unified data structure (306) is described further with respect to FIG. 5.

The data repository (300) also stores at least one parameter (308). The parameter (308) is a basis upon which the unified data structure (306) will be transformed into a transformed data structure (310) which is usable by the machine learning model (318), described below. The parameter (308) may take a variety of forms and may be more than one value or function. The parameter (308) may be defined, generally, as one or more functions or values, represented by the Greek letter, Θ, such that for a given user vector, u, a mapping function (312), p′_u, will be optimized for the target domain. The mapping function (312) is p′_u=f(p_u; Θ), where Θ is one or more parameters of function, f. Different parameters may be used. However, in one embodiment, the parameter (308), Θ, is based on a combination of: a) a first affinity score relating at least one user to a first subset of the items with which the at least one user interacted, and b) a second affinity score relating the user to a second subset of second items in the target domain with which the at least one user did not interact. More generally, an “affinity score” is a number which represents a closeness of relationship to an item. An item is a feature within a vector. Generation and use of the parameter (308), as well as a mathematical definition of the first and second affinity scores, are described with respect to FIG. 5.

The mapping function (312) is a mathematical function which, when applied to the unified data structure (306), results in the transformed data structure (310). The mapping function (312) is, generally, defined above. Generation and use of the mapping function (312) is described with respect to FIG. 5.

The transformed data structure (310), as indicated above, is usable by the machine learning model (318), described below. The transformed data structure (310) may be one or more vectors, with each vector representing data in both the target domain and the source domain associated with a particular user identifier. The transformed data structure (310) may have a different structure than the source domain data structure (302), the target domain data structure (304), or the unified data structure (306). For example, the data in the transformed data structure (310) may be transformed into a format which is optimized for use by the machine learning model (318), described below. In addition, the data contained within the transformed data structure (310) also may be transformed, by the mapping function (312), from the data in the unified data structure (306).

For example, the data in the transformed data structure (310) may be reconfigured latent data in the source domain data structure (302) such that the latent data is no longer latent. Rather, the transformed data has a clear meaning in the context of the target domain. In a specific example, a machine learning model (not necessarily machine learning model (318) may be used to find patterns among the source domain data and the target domain data such that the subject matter of the books the user reads are mappable to the subject matter of movies. Accordingly, the combined source domain data and target domain data in the transformed data structure (310) may be transformed. In particular, the transformation is to a data representation that is appropriate for the target domain.

The vectors in the transformed data structure (310) may take the form of a data array that includes a user identification and a corresponding subject of the first data in the source domain data structure (302) and the second data in the target domain data structure (304) that relate to the user identification.

The user vectors may correspond to second users having second user identifications. Then, the source domain data structure (302) further includes first usage data of a first computing environment by the first users. The target domain data structure (304) further includes second usage data of a second computing environment by the second users. The second computing environment is different than the first computing environment. For example, the first computing environment may be an online book selling service, and the second computing environment may be an movie streaming service. an assumption is made that the first usage data is larger than the second usage data. For example, an assumption is made that there is little or no data available from the second computing environment, but rich data available from the first computing environment. In a specific example, for at least some of the second users, the data from the second computing environment could be a single datum.

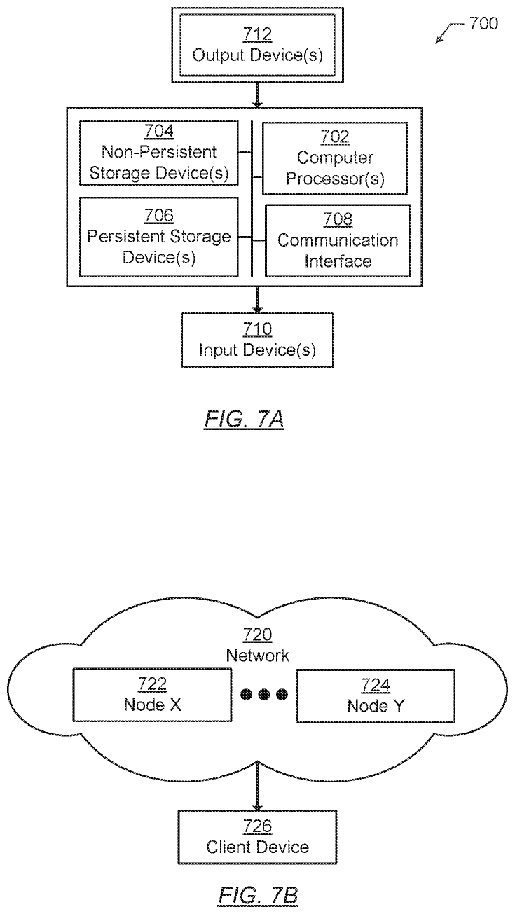

The data repository (300) may also store program code (314). The program code (314) may be software instructions for executing the steps in FIG. 5 on a computing system, such as that shown in FIG. 7A and FIG. 7B.

The data repository (300) also may store a recommendation (320) output by the machine learning model (318). The recommendation (320) relates to the target domain. The recommendation (320) may be presented in the user interface (322), as described below.

The system shown in FIG. 3 may also include a transformation engine (316). The transformation engine (316) is configured to execute the program code (314) to unify the source domain data structure (302) and the target domain data structure (304) to form the unified data structure (306). The transformation engine (316) may also be configured to execute the program code (314) to generate the transformed data structure (310) by applying the mapping function (312) to the vectors in the transformed data structure (310). Use of the transformation engine (316) is described further with respect to FIG. 5.

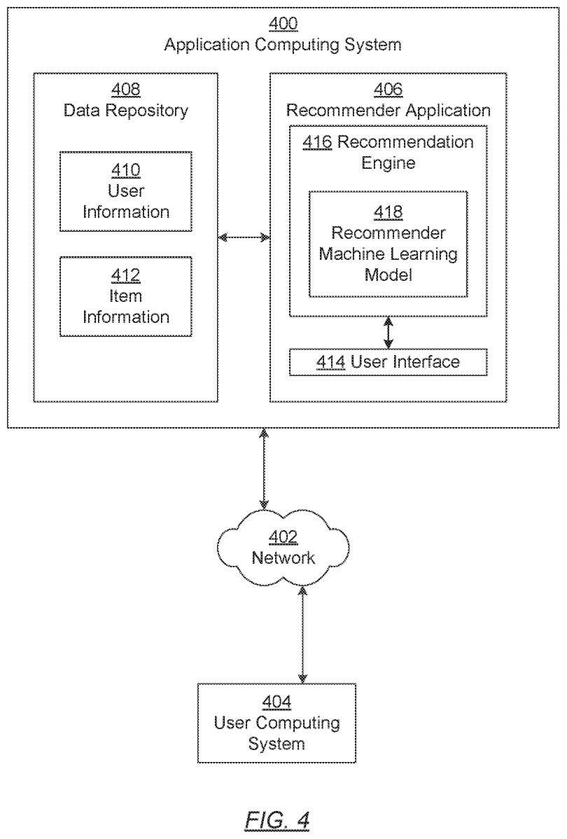

The system shown in FIG. 3 may also include the machine learning model (318). The machine learning model (318) may be a collaborative filtering recommender system. The machine learning model (318) may also be the recommender machine learning model (418) described respect to FIG. 4. The machine learning model (318) may also be some other machine learning model, such as a deep learning model or a neural network.

The system shown in FIG. 3 also may include the user interface (322). The user interface (322) is a display device operated by a computer system to which the user has access. In the example of FIG. 3, the user interface (322) shows the recommendation (320) in the form of recommended features available in Software Beta that the user might find attractive in view of the features the user used in Software Alpha. Because the transformed data structure (310) contains non-latent data which can be applied to the machine learning model (318), the user considers the recommendation (320) to be relevant even though the user has had little or no interaction with Software Beta.

FIG. 4 illustrates a recommender machine learning model, in accordance with one or more embodiments. Specifically, FIG. 4 shows a schematic diagram of machine learning based system that issues recommendations in accordance with one or more embodiments. Thus, FIG. 4 may be an example of the machine learning model (318) described with respect to FIG. 3.

As shown in FIG. 4, a user computing system (404) is connected via a network (402) to an application computer system (400). The application computing system (400) and user computing system (404) may be as described with respect to the computing system described below with reference to FIGS. 7A and 7B. Further, the network (402) may be the network (720) described below with reference to FIG. 7A. The user computing system (404) may support the user interface (322) of FIG. 3.

The user computing system (404) is any device that is connected to a user.

In one or more embodiments, the user computing system (404) includes functionality to execute a software application that connects the user to the recommender application (406). For example, the software application may be the recommender application (406), a local client application, a web browser, or another application.

The application computing system (400) includes a data repository (408), which could be data repository (300) of FIG. 3, and a recommender application (406). In one or more embodiments of the invention, the data repository (408) is any type of storage unit and/or device (e.g., a file system, database, collection of tables, or any other storage mechanism) for storing data. Further, the data repository (408) may include multiple different storage units and/or devices. The multiple different storage units and/or devices may or may not be of the same type or located at the same physical site. The data repository (408) includes item information (412) and user information (410). The item information (412) is information describing one or more items.

Recommender systems may use item vectors and user vectors. An item vector may be a set of features of an item, and thus may be a form of item information (412). A user vector may be the items with which the user interacts and could be user information (410). Both the item vector and the user vector may be one hot encoded. One hot encoding is a process by which data is converted into a form that could be provided to a machine learning model. The dot product of the user vector and item vector may be the affinity of a user to particular features. From there, the items that have those features may be recommended. The machine learning model may learn the weights for features that are used in the item vector.

An item is a target unit that may be recommended by the recommender machine learning model (418). For example, an item may be a movie, a clip, a song, a news article, a type of loan, document, physical or virtual product, a software, a software feature, or any other possible real or virtual object that may be recommended. The collection of items is the corpus from which an item may be recommended. For example, the collection of items may be a catalog of media offered by a company, a set of products offered by a company, or any other group of items. Item information (412) maintains metadata about the item. For example, the item information (412) may include a name of the item, one or more categories of the item, a keyword or key phrase descriptor of the item, a description of the item, and other information.

Continuing with the data repository (408), user information (410) maintains information about one or more users of the recommender application (406). User information may or may not include demographic information. In general, demographic information includes demographic properties. A demographic property is an internal characteristic of a population of humans. For example, a demographic property may be gender, age, race, religion, political affiliation, location, national origin, physical disability, mental disability, veteran status, genetic information, citizenship, and the like.

For each user, the user information (410) relates past usage history with a user identifier of the user. For example, past usage history may include the items that have been selected in the past, rating of a selected or not selected item, length of time that the item was used and other interaction with the item or detailing the user's experience with the item.

The data repository (408) is connected to a recommender application (406). The recommender application (406) is a software application that is configured to provide recommendations for items. In one or more embodiments, the recommender application (406) includes a user interface (414) and a recommendation engine (416). The recommendation engine (416) may be the machine learning model (318) of FIG. 3.

The user interface (414) is an interface configured to interact with the user. For example, the user interface (414) may be an audio interface, a graphical user interface, or any other interface to interact directly or indirectly with the user. In one or more embodiments, the user interface (414) is configured to present recommendations to the user and receive user information from the user. The user interface (414) is connected to the recommendation engine (416).

The recommendation engine (416) is a machine learning model that is configured to provide recommendations for the recommender application (406). In other words, the output of the recommender machine learning model (418) is one or more recommendations, where each recommendation is a recommendation of an item for a particular user. Specifically, the recommender engine (416) includes functionality to receive user information (410) and item information (412) and present a recommended item, that may be selectable by a user.

The recommender machine learning model (418) is a machine learning model that is configured to receive user information and item information and generate a recommendation of an item for a particular user. The recommender machine learning model (418) provides functionality to the computer system by enabling the computer system to predict whether a user will want to select a particular item. In other words, a huge catalog of items, from thousands to millions of items, may exist. Similarly, millions of users may be concurrently accessing the recommender application (406) and being provided recommendation. The recommender machine learning model (418) provides the tool by which the application computing system (400) can automatically predict which item or subset of items that the user will select or find to be of interest.

While FIG. 3 and FIG. 4 show a configuration of components, other configurations may be used without departing from the scope of the invention. For example, various components may be combined to create a single component. As another example, the functionality performed by a single component may be performed by two or more components.

FIG. 5 illustrates a method for enabling cross domain recommendations by a machine learning model, in accordance with one or more embodiments. The method shown in FIG. 5 may be implemented using the system shown in FIG. 3 and the computing system shown in FIG. 7A and FIG. 7B. Thus, the terms used with respect to the method FIG. 5 are defined with respect to the system described with respect to FIG. 3. The method of FIG. 5 may be characterized as a method for enabling cross domain recommendations by a machine learning model.

At step (500), a source domain data structure is combined with a target domain data structure to form a unified data structure. As described with respect to FIG. 3, first data in the source domain data structure are latent with respect to second data in the target domain data structure. Again, the unified data structure includes user vectors that combine the first data and the second data.

Additional details are now presented regarding the combination of the source domain data structure and the target domain data structure. In the example of FIG. 5, both the source domain data structure and the target domain data structure are matrices having values that represent user interactions with the respective domains. The source data structure is represented by matrix “S” and the target data structure is represented by matrix “T”. Each row in S and T describe the historical usage of user, “B”, with respect to the corresponding domain. Each column in S and T represents the usage of an item, “i”, with respect to the corresponding domain. Matrix “S” and matrix “T”, and their union matrix “M” (described below) may be sparse and may serve as an input. Thus, matrices “S”, “T”, and “M” may not be learned by a machine learning model.

The unified data structure may be an expanded matrix, “M”, which includes a single user identifier. Each row in M contains the historical interactions of the appropriate user with items from both S and T. Thus, if the number of items in matrix S is “n_S” and the number of items in T is “n_T”, then the number of items in the unified matrix, M, is: n_S+n_T. Thus, M may be a larger matrix relative to S or T, where all users are represented by vectors of items.

If necessary, M may be further modified. For example, if not already in the form of vectors, M may be transformed so that M is in the form of vectors suitable for input to a machine learning model.

In any case, after step 500, the users and/or items are represented by vectors. However, because of the sparseness of data in T and the latency in the data in S, further transformation of M is required to optimize M for use with respect to making predictions for the target domain.

In step 502, the user vectors are transformed by applying a mapping function to the user vectors to generate a transformed data structure. As indicated above, the mapping function relates, using at least one parameter, the relationships in the source domain data structure to the relationships in the target domain data structure. Additionally, as indicated above, the at least one parameter is based on a combination of: a) a first affinity score relating at least one user to a first subset of the items with which the at least one user interacted, and b) a second affinity score relating the at least one user to a second subset of the items in the target domain with which the at least one user did not interact. Additional details regarding step 502 are now provided, at least with respect to one possible implementation.

The purpose of step 502 is to modify the user and item vectors, so the user and item vectors may be optimized for the target domain. Note that in regular machine learning model algorithms, singleton users are not informative, since one cannot infer from a singleton user's preferences to other users' preferences. To see that point, consider a singleton user A who had an interaction with item, “i”. Any other user who had an interaction with item i cannot obtain insights from A, since there are not more items in the history of A.

Thus, the one or more embodiments take a novel approach to achieve domain adaptation. The one or more embodiments treat the representations of the users and content associated with them, which allows for the utilization of even singleton users. Concretely, the one or more embodiments transform user vectors and re-create item vectors as follows.

Given a user vector, “u”, apply a mapping function p′_u=f(p_u; Θ), such that p′_u will be optimized for the target domain, and Θ is the parameters of f( ) For abbreviation, the parameter Θ may be omitted from the notation. As an example, for function f, one can use a fully connected layer of a machine learning model to learn the mapping function, and hence Θ would be the learned weight matrix and the bias vector.

Let “V” be the item matrix of all target items. The matrix V may be initialized randomly and learned by the machine learning model during the optimization process. Thus, matrix V may be a learned, dense matrix. The vector of item “i” is denoted as “q_i”.

A goal is to learn matrix V and the parameters Θ of function f( ) so as to optimize the recommender machine learning model. To achieve the purpose, set “D”={(u,i,j)} is introduced. Set D is the collection of all interactions of users with items. Namely, for each user u who interacted with item i in the target domain, random item j is sampled such that u did not interact with j. The underlying assumption is the affinity between users and items the users chose to interact with is higher than the affinity to items the users did not interact with. The goal is to learn representations of users and items. The representations will allow one to distinguish between positive pairs (i.e., u and i) and negative pairs (i.e., u and j).

Specifically, one may maximize the log likelihood of obtaining the observed set D, plus a regularization term, “R”. The regularization term can be any known regularization term like L1 or L2 (the sum of the absolute values or squared of the parameters, respectively).

The likelihood of the tuple (u,i,j) is obtained by sigmoid of the differences between the corresponding affinity scores. The affinity score between user u and item i is given by the inner product of the corresponding vectors.

Thus, for example, for each tuple (u,i,j) in D: Let p_u be the user vector of user u in U. Then, obtain a modified user vector p′_u=f(p_u). Also obtain a positive affinity score between u and i, labeled as positive_score=q_i*p′_u. Also obtain a negative affinity score between u an j, labeled as negative_score=q_j*p′_u. Then, still for each tuple in D, perform the following: maximize log(sigmoid(positive_score-negative_score))+R.

The result of these calculations produces the matrix V and the parameters Θ of function f( ). The function f( ) can then be applied to the unified data structure, U, to achieve a transformed data structure, U^{T}.

Again, a user with a single interaction cannot contribute meaningfully to the machine learning model. However, after applying the mapping function, f( ), individual interactions are effectively related between the target domain and the source domain, and thus the transformed data structure, U^{T}, can leverage even singleton users in the target domain.

By the end of step 502, the result is the transformed data structure, U^{T}, and user vectors that are optimized for the target domain. Thus, U^{T} may be submitted to a machine learning model.

Note that the transformed data structure, U^{T}, may be different in form and not just in the data U^{T} contains. For example, additional transformations to the data structure may be applied so that U^{T} may be optimized for input to the recommender machine learning model.

Thus, at step 504, a decision may be made whether to perform a recommendation. If not, then at step 506 the transformed data structure, U^{T}, is stored in a data repository, and the method may terminate.

If so, then the transformed data structure, U^{T}, is submitted to the machine learning model. Then, at step 508, a recommendation relating to the target domain may be obtained from the machine learning model. The recommendation would then be presented to a user.

More formally, in order to generate recommendations for user, u, first obtain a modified user vector p′_u=f(p_u). Then, compute the inner product between p′_u and the item vectors in the catalog. Finally, choose the top “k” items, where k is the number of recommended items. The top k items are then presented to the user on a display device local to the user. To do so, the recommendation may be transmitted over a network to a local user computer for rendering on the local display device.

In summary, the exemplary formal procedures described above may be characterized as follows. The source domain data structure comprises a first matrix, “S”, having first features, “n₁ₖ” for each of the first users having user identities of “Iₖ”. The target domain data structure comprises a second matrix, “T”, having second features, “n₂ₖ” for each of the second users. The unified data structure comprises a third matrix, “U”, having, for each of the second users, third features comprising vectors labeled as “Uₖ” comprising features {Iᵢ, n₁ₖ, n₂ₖ}.

A matrix, “V” comprises an item matrix of all target items in Uₖ. A vector of an item, “i”, in V is defined as “q_i”. A set, “D” comprises a collection of interactions of users with items, such that D={(uₖ,i,j)}, such that for each user uₖ who interacted with an item i in the target domain, a random item j is sampled such that uₖ did not interact with j. “p_uₖ” is defined as a user vector of a user in Uₖ. The mapping function comprises p^{|}_uₖ=f(p_uₖ; Θ). “f” is a sigmoid function. Θ is parameters of f, with Θ comprising a learned weight matrix and a bias vector for a fully connected layer of a machine learning model recommender system. The first affinity score is defined as P⁺, which is a positive score representing an affinity between uₖ and i, and P⁺=q_i*p^{|}_u. The second affinity score is defined as P⁻, which is a negative score representing an affinity between uₖ and j, and P⁻=q_j*p^{|}_u. R is a regularization term.

Therefore, transforming may include: for each tuple (uₖ, i, j) in D, obtain a modified user vector p^{|}_u=f(p_u), maximize log(sigmoid(P⁺−P⁻))+R. However, the one or more embodiments contemplate other mapping functions for transformation of the unified matrix, U.

While the various steps in this flowchart are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the invention. By way of an example, determination steps may not require a processor to process an instruction unless an interrupt is received to signify that condition exists in accordance with one or more embodiments of the invention. As another example, determination steps may be performed by performing a test, such as checking a data value to test whether the value is consistent with the tested condition in accordance with one or more embodiments of the invention.

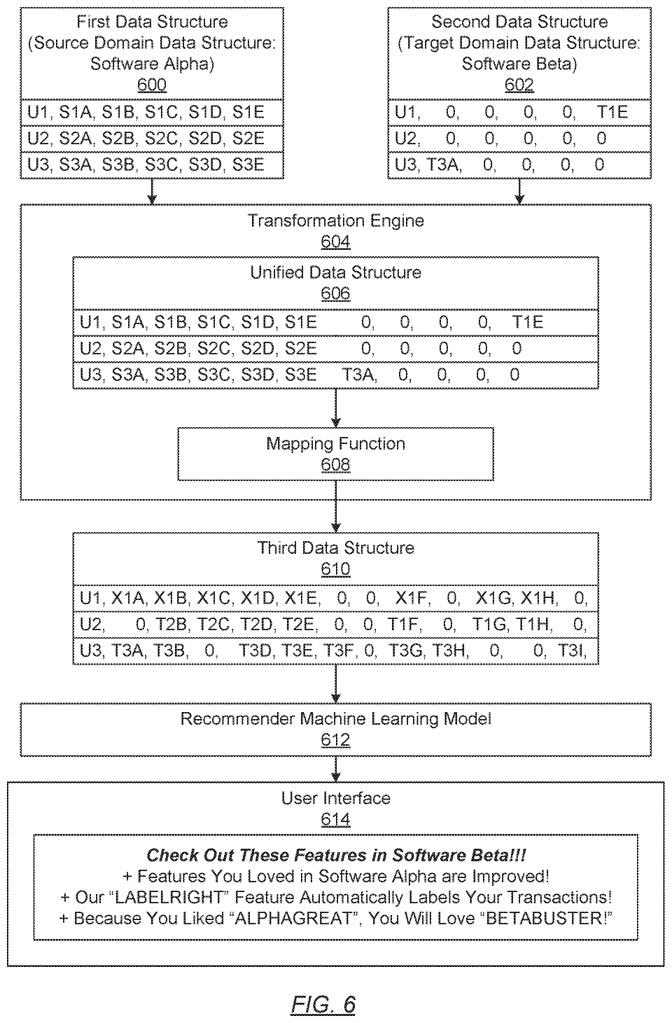

FIG. 6 illustrates a specific example of data structures used in a method for enabling cross domain recommendations by a machine learning model, in accordance with one or more embodiments. The following example is for explanatory purposes only and not intended to limit the scope of the invention. Thus, FIG. 6 is a variation of the system of FIG. 3, but intended to be described more in the context of the data structures being used.

The first data structure (600) is the source domain data structure in the example of FIG. 6. The first data structure (600) relates information regarding a software product called “Software Alpha”. The first data structure (600) may be characterized as a table or matrix, where users are identified by “U” followed by a number to indicate an identity of the user. Each row of the first data structure (600) is associated with a single user. The columns of the first data structure (600) contain values that represent items relating to Software Alpha. The items may be many different types of information tracked with respect to Software Alpha, such as the number of times opened, specific features used, the number of times specific features are used, how many times the user recommended a feature, purchase history of the user, and the like. The items are represented by “S” followed by a number and a letter. The number represents the user number, and the letter represents the value entry for the item in question.

As can be seen, the first data structure (600) is rich with data. In the example of FIG. 6, each of three users has an entry for five items in the first data structure (600). However, in the case of real enterprise systems, the first data structure (600) may not include every user or every item that is potentially available. In other words, in other examples of first data structure (600), certain users or certain items could be omitted.

However, the target domain is for a different product, Software Beta. The user has had little interaction with Software Beta, and possibly the information regarding the user's knowledge of Software Beta comes from other sources. For example, the fact that a second user recommended Software Beta to the user in question may be the only datum. Nevertheless, the company that manages both Software Alpha and Software Beta desires to provide automatically generated recommendations to the first user regarding Software Beta. However, the information in the first data structure (600) is latent with respect to the target domain, which is Software Beta.

Nevertheless, the second data structure (602), which is the target domain data structure, may be constructed. The second data structure (602) also includes a list of users, designated by the letter U followed by a number which identifies the user uniquely. At least one of the users in the second data structure (602) is common to the list of users in the first data structure (600). In the example of FIG. 6, all three users are common to both data structures. For purposes of illustration, U1 is the user in question: The user for whom a recommendation is to be automatically generated.

However, the second data structure (602) is sparse. Most entries for items in the second data structure (602) are “0”, representing the null set (i.e., no data). Information that is available for a few items is represented by the letter T, designating information about an item in the second data structure (602). The number following the letter T indicates the user identifier number. The letter following the user identifier number represents the value of the entry for the corresponding item.

The first data structure (600) and the second data structure (602) are provided to the transformation engine (604). The transformation engine (604) combines the first data structure (600) and the second data structure (602) into a unified data structure (606). In the example of FIG. 6, the unified data structure (606) includes the three users U1, U2, and U3. The matrix of the unified data structure (606) is expanded to include all of the entries for both the first data structure (600) and the second data structure (602).

The transformation engine (604) then applies the mapping function (608) to unified data structure (606). The mapping function (608) is described above with respect to FIG. 5.

The result of applying the mapping function is a third data structure (610). Note that the third data structure (610) still includes the three users, U1, U2, and U3. However, the rows of the table now contain different information. Additionally, in the example of FIG. 6, the number of columns (items) has been expanded relative to the first data structure (600) and the second data structure (602). Thus, the third data structure (610) is different in structure from either the first data structure (600) or the second data structure (602). In particular, the third data structure (610) includes additional information regarding the positive affinity and negative differences calculated as part of the mapping function (608). Furthermore, the data from the first data structure (600) has been transformed into a format that has a meaning that is more relevant to the target domain. Yet further, the first data structure (600) may contain hyperparameters which are used by the recommender machine learning model (612). Finally, the third data structure (610) is transformed, relative to the unified data structure (606), into a series of vectors that have been formatted for input into the recommender machine learning model (612). Thus, the third data structure (610) is different than the first data structure (600), the second data structure (602), or the unified data structure (606) in both structure and the data contained therein.

The vectors of the third data structure (610) are then supplied as input to the recommender machine learning model (612), which in the example of FIG. 6 is a collaborative filtering deep learning model. The recommender machine learning model (612) is executed and finds inference and patterns among the data in the third data structure (610). The recommender machine learning model (612) outputs a vector which contains data that indicates that two features are likely to be of particular interest to user U1: the “labelright” feature of Software Beta which automatically labels transactions received by Software Beta, and the “Betabuster” feature which performs deep analysis of financial transactions recorded by the user.

As a result, rules and/or policies in a business enterprise are used to generate recommendations and/or full advertisements to the user, U1. The recommendations and/or full advertisements are sent to be displayed on a user interface (614). The text shown displayed on the user interface (614) may contain hyperlinks so that a user may automatically find more information about Software Beta, download Software Beta for a fee, link to a discussion board of current users Software Beta, or help the user take some other computerized action.

Embodiments of the invention may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be used improved by including the features and elements described in the disclosure.

For example, as shown in FIG. 7A, the computing system (700) may include one or more computer processors (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (712) (e.g., Bluetooth interface, infrared interface, network interface, optical interface, etc.), and numerous other elements and functionalities that implement the features and elements of the disclosure.

The computer processor(s) (702) may be an integrated circuit for processing instructions. For example, the computer processor(s) (702) may be one or more cores or micro-cores of a processor. The computing system (700) may also include one or more input devices (710), such as a touchscreen, keyboard, mouse, microphone, touchpad, electronic pen, or any other type of input device.

The communication interface (708) may include an integrated circuit for connecting the computing system (700) to a network (not shown) (e.g., a local area network (LAN), a wide area network (WAN) such as the Internet, mobile network, or any other type of network) and/or to another device, such as another computing device.

Further, the computing system (700) may include one or more output devices (712), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage device(s) (704), and persistent storage device(s) (706). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (700) in FIG. 7A may be connected to or be a part of a network. For example, as shown in FIG. 7B, the network (720) may include multiple nodes (e.g., node X (722), node Y (724)). Each node may correspond to a computing system, such as the computing system (700) shown in FIG. 7A, or a group of nodes combined may correspond to the computing system (700) shown in FIG. 7A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (700) may be located at a remote location and connected to the other elements over a network.

Although not shown in FIG. 7B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (722), node Y (724)) in the network (720) may be configured to provide services for a client device (726). For example, the nodes may be part of a cloud computing system. The nodes may include functionality to receive requests from the client device (726) and transmit responses to the client device (726). The client device (726) may be a computing system, such as the computing system (700) shown in FIG. 7A. Further, the client device (726) may include and/or perform all or a portion of one or more embodiments of the invention.

The computing system (700) or group of computing systems described in FIGS. 7A and 7B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system (700) performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system (700), in performing one or more embodiments of the invention, may extract one or more data items from the obtained data. For example, the extraction may be performed as follows by the computing system (700) in FIG. 7A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system (700). For example, the computing system (700) of FIG. 7A, while performing one or more embodiments of the invention, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system (700) in FIG. 7A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system (700) of FIG. 7A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system (700). For example, data may be presented to a user using a vibration generated by a handheld computer device with a predefined duration and intensity of the vibration to communicate the data.

The above description of functions presents only a few examples of functions performed by the computing system (700) of FIG. 7A and the nodes and/or client device in FIG. 7B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
combining a source domain data structure and a target domain data structure to form a unified data structure, wherein:
first data in the source domain data structure are latent with respect to second data in the target domain data structure, and
the unified data structure comprises a plurality of user vectors that combine the first data and the second data;
transforming the plurality of user vectors, to generate a transformed data structure, by applying a mapping function to the plurality of user vectors, wherein:
the mapping function relates, using at least one parameter, a first plurality of relationships in the source domain data structure to a second plurality of relationships in the target domain data structure,
the at least one parameter is based on a combination of: a) a first affinity score relating the at least one user to a first subset of the second plurality of items with which the at least one user interacted, and b) a second affinity score relating the at least one user to a second subset of the second plurality of items in the target domain with which the at least one user did not interact;
submitting the transformed data structure into a machine learning model; and
obtaining, from the machine learning model, a recommendation relating to the target domain.

2. The method of claim 1 wherein:
the source domain data structure comprises the first plurality of relationships between a first plurality of users to a first plurality of items in a source domain,
the target domain data structure comprises the second plurality of relationships between a second plurality of users to a second plurality of items in a target domain, and
the first plurality of users and the second plurality of users include at least one user in common.

3. The method of claim 1, further comprising:
determining the at least one parameter from a matrix data structure comprising a matrix of target domain items in the unified data structure.

4. The method of claim 3, wherein the machine learning model comprises a collaborative filtering recommender system.

5. The method of claim 1, wherein each of the plurality of user vectors comprises a corresponding data array comprising a corresponding user identification and a corresponding subset of the first data and the second data that relate to the corresponding user identification.

6. The method of claim 5, wherein:
the plurality of user vectors corresponds to the plurality of second users having a plurality of second user identifications,
the source domain data structure further comprises first usage data of a first computing environment by the first plurality of users,
the target domain data structure further comprises second usage data of a second computing environment by the second plurality of users,
the second computing environment is different than the first computing environment, and
the first usage data is larger than the second usage data.

7. The method of claim 6, wherein the second usage data comprises, for the at least one user, a single datum.

8. A system comprising:
a data repository storing:
a source domain data structure comprising a first plurality of relationships between a first plurality of users to a first plurality of items in a source domain,
a target domain data structure comprising a second plurality of relationships between a second plurality of users to a second plurality of items in a target domain, wherein first data in the source domain data structure is latent with respect to second data in the second domain data structure, and
a unified data structure comprising a plurality of user vectors that combine the first data and the second data,
at least one parameter based on a combination of: a) a first affinity score relating the at least one user to a first subset of the second plurality of items with which the at least one user interacted, and b) a second affinity score relating the at least one user to a second subset of the second plurality of items in the target domain with which the at least one user did not interact,
a mapping function which relates, using the at least one parameter, the first plurality of relationships in the source domain to the second plurality of relationships in the target domain,
a transformed data structure comprising a transformation of the plurality of user vectors, and
program code; and
a transformation engine configured to execute the program code to:
unify the source domain data structure and the target domain data structure to form the unified data structure, and
generate the transformed data structure by applying the mapping function to the plurality of user vectors.

9. The system of claim 8, further comprising:
a machine learning model, wherein:
the transformed data structure is configured to be input to the machine learning model,
the data repository further stores a recommendation output by the machine learning model, and
the recommendation relates to the target domain.

10. The system of claim 7, wherein the machine learning model comprises a collaborative filtering recommender system.

11. The system of claim 8, wherein each of the plurality of user vectors comprises a corresponding data array comprising a corresponding user identification and a corresponding subset of the first data and the second data that relate to the corresponding user identification.

12. The system of claim 11, wherein:
the plurality of user vectors corresponds to the plurality of second users having a plurality of second user identifications,
the source domain data structure further comprises first usage data of a first computing environment by the first plurality of users,
the target domain data structure further comprises second usage data of a second computing environment by the second plurality of users,
the second computing environment is different than the first computing environment, and
the first usage data is larger than the second usage data.

13. The system of claim 12, wherein the second usage data comprises, for at least some of the second plurality of users, a single datum.

14. A non-transitory computer readable storage medium storing program code, which when executed by a computer, performs a computer-implemented method, wherein the program code comprises program code for:
combining a source domain data structure and a target domain data structure to form a unified data structure, wherein:
first data in the source domain data structure are latent with respect to second data in the target domain data structure,
the unified data structure comprises a plurality of user vectors that combine the first data and the second data;
transforming the plurality of user vectors, to generate a transformed data structure, by applying a mapping function to the plurality of user vectors, wherein:
the mapping function relates, using at least one parameter, a first plurality of relationships in the source domain data structure to a second plurality of relationships in the target domain data structure,
the at least one parameter is based on a combination of: a) a first affinity score relating the at least one user to a first subset of the second plurality of items with which the at least one user interacted, and b) a second affinity score relating the at least one user to a second subset of the second plurality of items in the target domain with which the at least one user did not interact;
submitting the transformed data structure into a machine learning model; and
obtaining, from the machine learning model, a recommendation relating to the target domain.

15. The non-transitory computer readable storage medium of claim 14, wherein the program code further comprises program code for:
determining the at least one parameter from a matrix data structure comprising a matrix of target domain items in the unified data structure.

16. The non-transitory computer readable storage medium of claim 15, wherein the machine learning model comprises a collaborative filtering recommender system.

17. The non-transitory computer readable storage medium of claim 14, wherein each of the plurality of user vectors comprises a corresponding data array comprising a corresponding user identification and a corresponding subset of the first data and the second data that relate to the corresponding user identification.

18. The non-transitory computer readable storage medium of claim 17, wherein:
the plurality of user vectors corresponds to the plurality of second users having a plurality of second user identifications,
the source domain data structure further comprises first usage data of a first computing environment by the first plurality of users,
the target domain data structure further comprises second usage data of a second computing environment by the second plurality of users,
the second computing environment is different than the first computing environment, and
the first usage data is larger than the second usage data.

19. The non-transitory computer readable storage medium of claim 18, wherein the second usage data comprises, for the at least one user, a single datum.

20. The non-transitory computer readable storage medium of claim 14, wherein the program code further comprises program code for:
storing the transformed data structure in a data repository.
